(19) United States
(12) Patent Application Publication
(10) Pub. No.: US 2013/0054412 A1
(43) Pub. Date: Feb. 28, 2013

(54) METHODS AND SYSTEMS FOR CONTACTLESS PAYMENTS FOR ONLINE ECOMMERCE CHECKOUT

(71) Applicants: Brian Brendell, Springfield, NJ (US); I-Hsin Chuang, Brooklyn, NY (US); Carlos Korten, Brooklyn, NY (US); Nicole Lewis, New York, NY (US)

(72) Inventors: Brian Brendell, Springfield, NJ (US); I-Hsin Chuang, Brooklyn, NY (US); Carlos Korten, Brooklyn, NY (US); Nicole Lewis, New York, NY (US)

(73) Assignee: American Express Travel Related Services Company, Inc., New York, NY (US)

(21) Appl. No.: 13/215,111

(22) Filed: Aug. 22, 2011

(51) Int. Cl. G06Q 30/06

(52) U.S. Cl. 705/26.41

(57) ABSTRACT

A process of conducting a contactless payment in an online transaction comprises initiating, at a computer-based system, an online transaction based on a consumer selection, transmitting, from an RF device, consumer information to the computer-based system. The consumer information may provide at least one of shipping information, account information, and billing information for completing the online transaction. Further, the method includes populating a check-out screen with consumer information from the radio frequency device. The consumer is able to confirm the online transaction and associated information prior to submission for processing. In various embodiments of conducting the contactless payment of an online transaction, the RF device may be at least one of a transponder, a mobile phone, a smart phone, or a fob. The contactless-enabled device may at least one of a desktop computer, a laptop computer, a tablet computer, a notebook computer, a mobile phone, or a smart phone.

### FIELD

The present disclosure generally relates to contactless payments for online ecommerce checkout.

### BACKGROUND OF THE DISCLOSURE

In a typical online transaction, a consumer begins ordering a product or service from a merchant website and then has to fill out various fields in an order form before completing the checkout. The various fields include shipping address, billing address, account information, and the like. Filling out the various fields can be a tedious task, and requires the consumer to locate additional financial information. Some websites allow a consumer to store shipping addresses and account information so that the consumer may avoid providing the information during a later transaction. However, the consumer may be concerned with storing that sensitive information on a local computer or in an online merchant account. In addition, the consumer then may be concerned about submitting the account information because it may be vulnerable for theft either during transmission or when stored at the merchant.

In light of the foregoing, there exists a need for a system, method and/or computer program product that provides consumer convenience in populating fields for conducting online transactions, and also for facilitating the financial aspects of an online transaction in a secure manner.

### SUMMARY

In various embodiments a contactless payment system for online transactions comprises a contactless-enabled device having customer account information, a computer-based system having reader and a consumer interface, a merchant system configured display a merchant website, and an authorization system configured to receive transaction information and approve an online transaction. The transaction takes place at the consumer interface of the merchant website, and the contactless-enabled device provides the customer account information to the computer-based system in a contactless manner. The contactless-enabled device may communicate using radio frequency, or more specifically, near-field communication protocols. The computer-based system uses the customer account information to facilitate the online transaction.

In various methods of the disclosure, a method of conducting a contactless payment for an online transaction comprises initiating, at a computer-based system, an online transaction based on a consumer selection, transmitting, from a contactless-enabled device, consumer information to the computer-based system. The consumer information may provide at least one of shipping information, account information, and billing information for completing the online transaction. Further, the method includes populating, by the computer-based system, a check-out screen with consumer information from the contactless-enabled device. The consumer is able to confirm the online transaction and associated information prior to submission of the online order for processing. In various embodiments of the systems and methods of conducting the contactless payment of an online transaction, the contactless-enabled device may be at least one of a transponder, a mobile phone, a smart phone, or a fob. A contactless-enabled reader may at least one of a desktop computer, a laptop computer, a tablet computer, a notebook computer, a mobile phone, or a smart phone.

In other various methods, a method of conducting a contactless payment for an online transaction comprises generating, at a computer-based system, an online transaction order based on input from a consumer, receiving, at a contactless-enabled reader of the computer-based system, account information from a contactless-enabled device; and populating, by the computer-based system, the account information into the online transaction order. Furthermore, the method may also include receiving, at the computer-based system, confirmation of the online transaction order in response to a consumer review, and transmitting, by the computer-based system, the online transaction order to an authorization system for processing the transaction under business as usual standards.

In various embodiments, the information provided for facilitating contactless payment is based on a gesture made with the contactless-enabled device or based on voice activation by the user. The contactless-enabled device may be enabled for transmitting the account information to the contactless-enabled reader in response to voice activation of the contactless-enabled device. The voice activation is based on phrases, for example, a first phrase may correspond to a first set of account information, and a second phrase may correspond to a second set of account information.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an overview of an exemplary system for conducting contactless payments in an online transaction environment;

FIG. 2 is a flowchart illustrating one exemplary process of conducting contactless payments in an online transaction environment;

FIG. 3 is an alternative embodiment of a process of conducting contactless payments in an online transaction environment using a rotating number;

FIG. 4 is an alternative embodiment of a process of conducting contactless payments in an online transaction environment using a unique identifier;

FIG. 5 is an alternative embodiment of a process of conducting contactless payments in an online transaction environment using loyalty programs;

FIG. 6 illustrates an exemplary system for conducting contactless payments in an online transaction using an application-to-application transfer; and

FIG. 7 is a block diagram of an exemplary embodiment of a computer system.

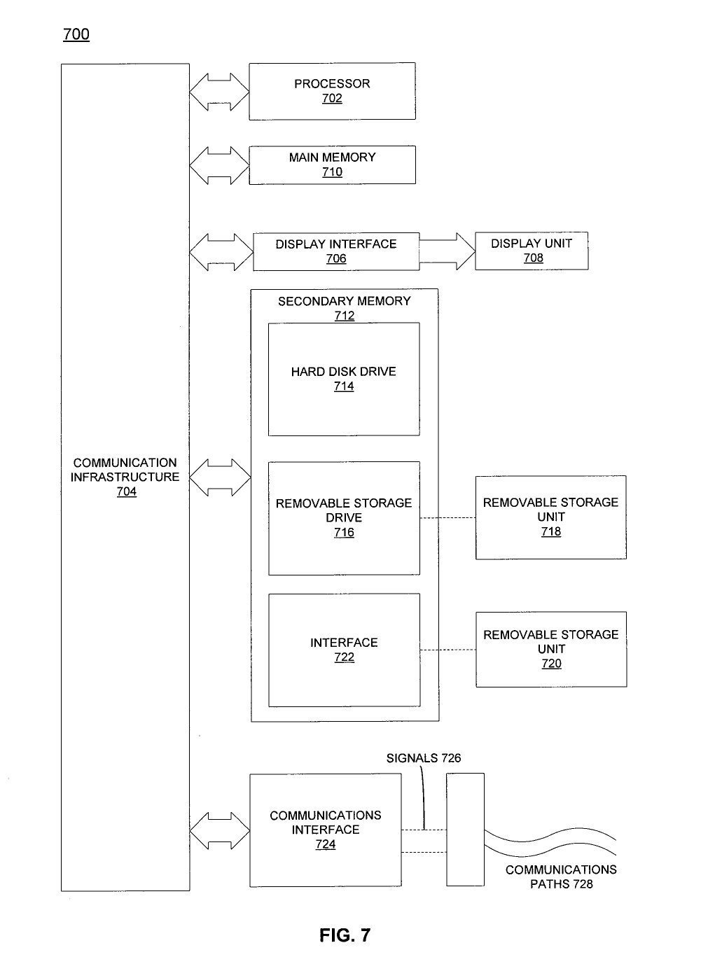

### DETAILED DESCRIPTION

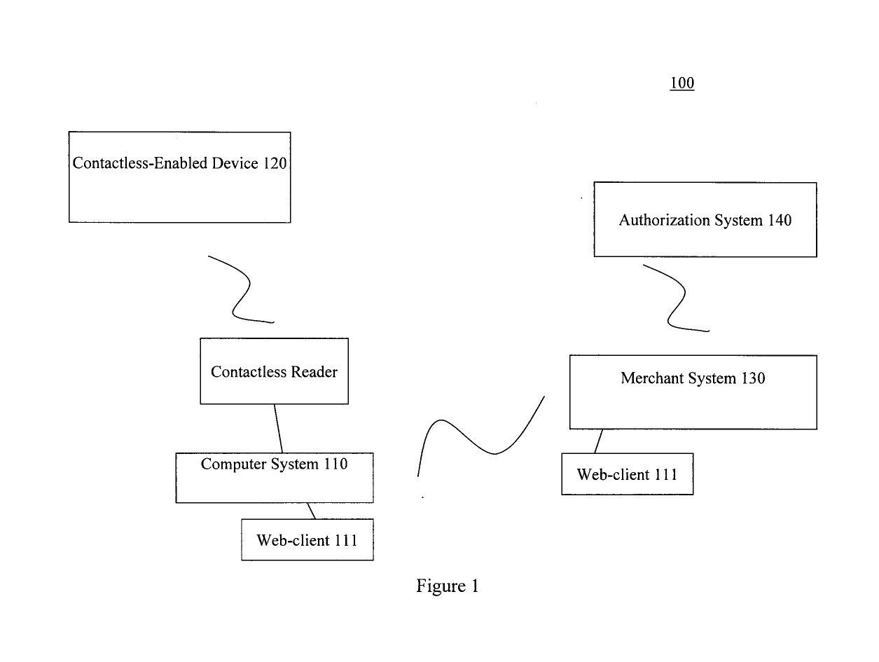

In various exemplary embodiments, a system, method and/or computer program product for conducting a contactless online transaction is disclosed. FIG. 1 is an overview of an exemplary system 100 for conducting a contactless online transaction, where the system 100 comprises a computer system 110 with a radio frequency identification (RFID) reader, a contactless device 120, a merchant system 130, and an authorization system 140. Computer system 110 may be any computer system having a user interface and an RFID reader. The computer system 110 may be a desktop computer, a laptop computer, a tablet computer, a notebook computer, mobile phone, smart phone, and the like. Furthermore, the RFID reader may be internal to the computer system 110 or may be external to the computer system 110. Contactless device 120 provides customer information, and may be a radio frequency (RF) device. Authorization system 140 may include any entity that offers transaction account services, such as a financial institution.

Merchant system 130 may comprise any type of hardware and/or software (e.g., a computer server) configured or configurable to generate and/or display a merchant website (e.g., electronic commerce website). Typically, such a server comprises a rack mountable server appliance running a suitable server application (e.g., IIS). Phrases and terms similar to “business” or “merchant” may be used interchangeably with each other and shall mean any person, entity, distributor system, software and/or hardware that is a provider, broker and/or any other entity in the distribution chain of goods or services.

Merchant system 130 may include a merchant web-client 131 and computer system 110 may include a customer web-client 111. Client web-client 111 and/or merchant web-client 131 may include any software and/or hardware (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client 111 and/or 131 may run Microsoft Internet Explorer, Mozilla Firefox, Google Chrome, Apple Safari, or any other of the myriad software packages available for browsing the interne.

System 100 may include or interface with any of the accounts or devices discussed herein, an contactless device 120 such as a radio frequency device, and RFID reader in communication with the contactless device 120 (which may include a fob), or communications between an initiator and a target enabled by near field communications (NFC). In various embodiments, contactless device 120 communicates information in different ways, such as QR cords, Bluetooth, barcode switch, and the like. Typical contactless devices 120 may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

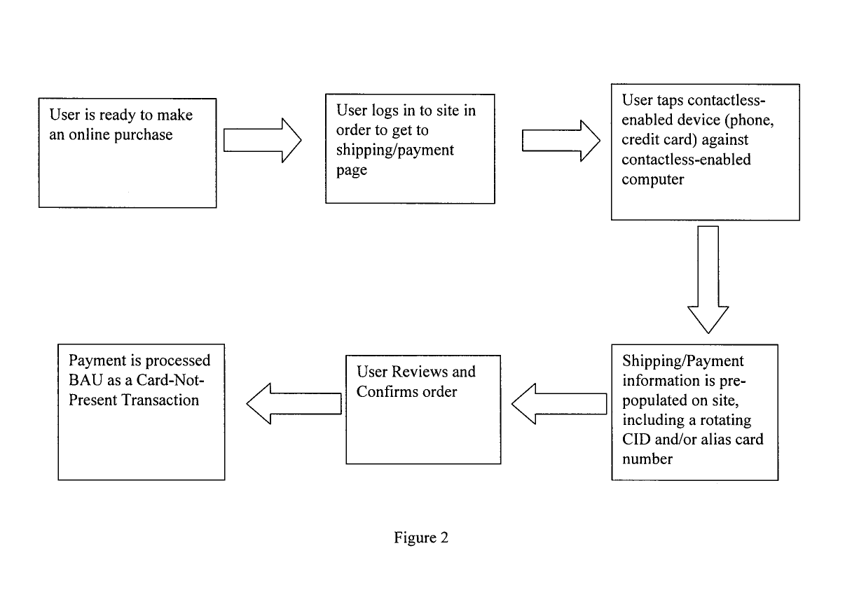

With reference to FIG. 2, when a customer is ready to make an online purchase from an online merchant, the customer typically provides account information on a checkout page of the online merchant. In various embodiments, the customer provides the account information by “tapping” the contactless device 120 with computer system 110 having the RFID reader. The “tapping” motion means placing the contactless device 120 in close proximity to the RFID reader. This may include physically touching the contactless device 120 to the RFID reader, or at least placing the contactless device 120 in close enough proximity to enable an interrogation signal to be transmitting and received. In various embodiments, tapping the contactless device 120 transmits customer information to the computer system 110 via the RFID reader. The customer information is transmitted to pre-populate an online merchant order form on the computer system 110.

In various exemplary embodiments, the manner in which the contactless device 120 is tapped corresponds to different information on the contactless device 120. The contactless device 120 may be “tapped” with the RFID reader by waving the RF device in close proximity, where the waving with a gesture formation is an identifier. For example, waving the RF device with a gesture formation in the form of a circular shape may result in the population of the online transaction fields using a first set of data. Likewise, waving the RF device with a gesture formation in the form of a square yields similar results and population of the online transaction fields using a second set of data. For example, the first set of data may be the account information of the customer's American Express credit card. The second set of data may be the account information of the customer's Visa credit card. In another example, the first set of data may contain the customer's home address as the shipping address, whereas the second set of data may contain the customer's work address as the shipping address. For more information regarding a gesture formation identifier, refer to U.S. patent application Ser. No. 13/168,072, entitled “SYSTEMS AND METHODS FOR GESTURE-BASED INTERACTION WITH COMPUTER SYSTEMS,” filed Jun. 24, 2011, which is hereby incorporated by reference.

With respect to providing data or approving actions, in various embodiments, a customer may approve different levels of actions to be taken. For example, the customer may approve of transactions that are reviewable before final approval, transactions passing only certain information, or a transaction that is completed based on a single approval. “Approval” in various embodiments may be defined in terms of the customer interaction with the contactless device 120, and not in terms of the data transferred between the contactless device and the RFID reader. For example, a single tap approval is based on the customer selecting to complete a transaction in response to a single approval on the contactless device. Although one or more interrogation signals and data transfers may occur between the contactless device and the RFID reader, no additional action is needed by the customer.

In various embodiments, a timeout function may be included in various customer approvals. For the various embodiments described herein, a contactless device may only be enabled to facilitate transactions for a predetermined time before the device is disabled in response to a timeout function.

In addition to a gesture being an identifier, a voice activated phrase may also be an identifier. In various embodiments, a customer may have to speak a specific phrase into the RF device to unlock the ability to initiate a transaction. Each phrase may be linked to a shipping address and/or account information. Speaking the specific phrase unlocks the RF device so that the RF device and stored information is available next time the RF device is tapped. This unlocking phrase increases the device security and prevents the RF device from transmitting information unintentionally or if an unauthorized reader is attempting to access the information. Furthermore, the device security may be enhanced by requiring that it is the customer's voice that speaks the phrase.

Once the online merchant order form is populated, any remaining fields may be filled by the customer. The remaining fields may be data or selections specific to the online transaction, such as selecting the shipping option (standard, express, overnight, etc.). The customer may review the online order for accuracy and edit as desired or needed. After the online merchant order form is confirmed and submitted, the online order and corresponding payment is processed under business-as-usual standards as a card-not-present transaction.

In various embodiments, tapping the RF device 120 with the RFID reader transmits not only various customer data, but may also transmit various account information. In various embodiments, a customer's credit card information is pre-populated the same as if the customer had typed the account information into the online merchant order form. In various embodiments, the account information pre-populated includes a rotating card identification number (CID) and/or an alias account code. The CID is typically a three- or four-digit value printed on the card or signature strip, but not encoded on the magnetic stripe. In the embodiments, the rotating CID rotates values in a predetermined manner. For example, the CID value may be loaded from a pre-loaded file also stored on the authorization system 140 or the CID value may change based on an algorithm known by the authorization system 140. Similarly, an alias account code is pseudo-account code that corresponds to the customer's account code on the authorization system 140. Pre-populating the online merchant order form with at least one of a rotating CID or an alias account code increases account security and the prevention of fraudulent transactions.

The customer data and account information may be part of a virtual wallet program which stores a plurality of data associated with various aspects of a customer. The plurality of data may be stored multiple places. In various embodiments, the data may be stored on the contactless device 120, and then passed to the reader 110 and local computer before being sent to the merchant system 120 or authorization system 140. In another embodiment, the data may be stored on the local computer, where the contactless device 120 is a trigger that facilitates the transfer from the local computer to the merchant system 130 or authorization system 140. In various embodiments, the data may be stored in a cloud computing system, and transferred based on request initiated by contactless device 120. Moreover, the plurality of data may be stored at one or a combination of these embodiments. In various embodiments, multiple areas of data storage may be used to increase transaction security. In various embodiments, contactless device 120 may only transfer a security identification code and the customer information may be retrieved from an alternate location. Additionally, in various embodiments, a customer identification may be verified by matching data from the contactless device 120 to data stored on at least one of the local computer, merchant system 130, authorization system 140, or a cloud system storage.

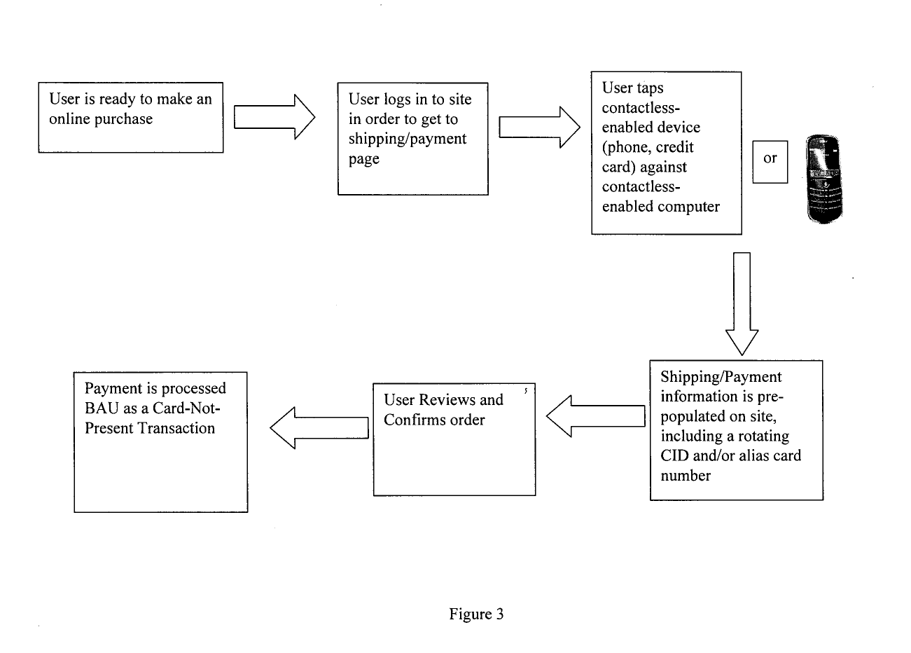

In various embodiments and with reference to FIG. 3, pre-populating the online merchant order form includes not only providing at least one of the rotating CID or the alias account code, but also includes providing at least one additional data point that identifies the customer. In exemplary embodiments, the at least one additional data point informs the merchant system 130 and/or the authorization system 140 that the transaction is a contactless transaction and being submitted with the use of RF device 120.

Another feature to increase security, in various embodiments, is to disable the account code and CID for contactless payment use. Further, the account code and CID may also be disabled for card not present (CNP) transactions. The customer activates the RF device for contactless payment use, and the authorization system will no longer accept the original account code and CID as valid during at least one of CNP or contactless transactions. The original account code and CID are replaced with rotating numbers known to the authorization system. In contact transactions, also known as card present transactions, the original credit card is valid and provides standard account information. The authorization system is able to differentiate between contact and contactless and CNP transactions based on the at least one additional data point.

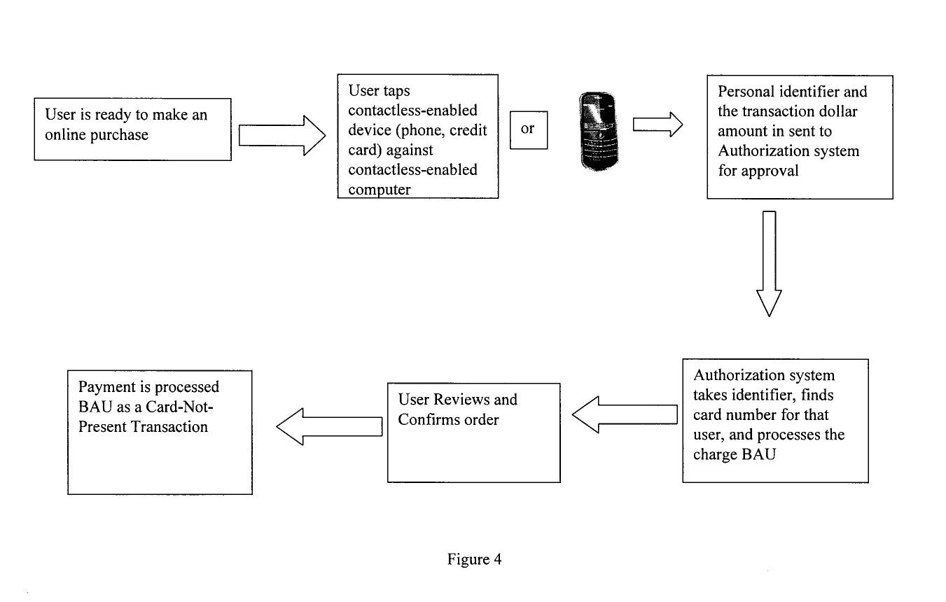

In other alternative embodiments and with respect to FIG. 4, the information provided to pre-populate the online merchant order form includes a personal identifier of the customer. The personal identifier may be a unique number associated with the RF device, such as a phone number. Furthermore, the personal identifier may be any unique number stored on the RF device. The shipping address of the customer may also be provided by the RF device or may be provided by the authorization system. The personal identifier and a transaction amount are sent by the merchant system to the authorization system. The authorization system receives the personal identifier and the transaction amount. The personal identifier is associated with a customer account, which may be used to process the online transaction under business-as-usual standards. The customer account code is not passed between the merchant system and the authorization system, thereby increasing transaction security. In exemplary embodiments, the shipping address for the online transaction is provided by the authorization system. The shipping address is the address associated with the customer account. In various embodiments, the authorization provides approval of the online transaction and the shipping address to the merchant system. The merchant system allows the customer to review and confirm the online transaction, including the shipping address provided by the authorization system. In this embodiment, the customer may edit the shipping address as needed. Furthermore, the online transaction is processed in response to confirmation by the customer. For more information regarding a personal identifier and processing a transaction, refer to U.S. patent application Ser. No. 12/343,178, entitled “SYSTEM AND METHOD FOR PREVENTING UNAUTHORIZED ACCESS TO FINANCIAL ACCOUNTS,” filed Dec. 23, 2008, which is hereby incorporated by reference.

In various exemplary embodiments, an RF device may be used as an authentication mechanism and log a user into a secure website, such as a secure merchant website. The authentication mechanism can replace a username and password on the secure merchant website. In an exemplary embodiment, a user would tap the RF device with an RFID reader of a computer system. A third party system, such as an authorization system, would verify the user is a valid user and provide credentials to the secure merchant website. Once the user is logged into the secure merchant website, the online transaction may proceed. In various embodiments, a user may tap the RF device and proceed to complete the online transaction as described above. Transaction approval and a shipping address may be supplied to the merchant system, along with the user verification. This would be a single “tap” checkout as the user only provides a single approval of data transfer. The transaction approval and shipping address may be supplied to the merchant system at the same time as the user verification, or the transaction approval and shipping address may be supplied at some point after user verification is transmitted.

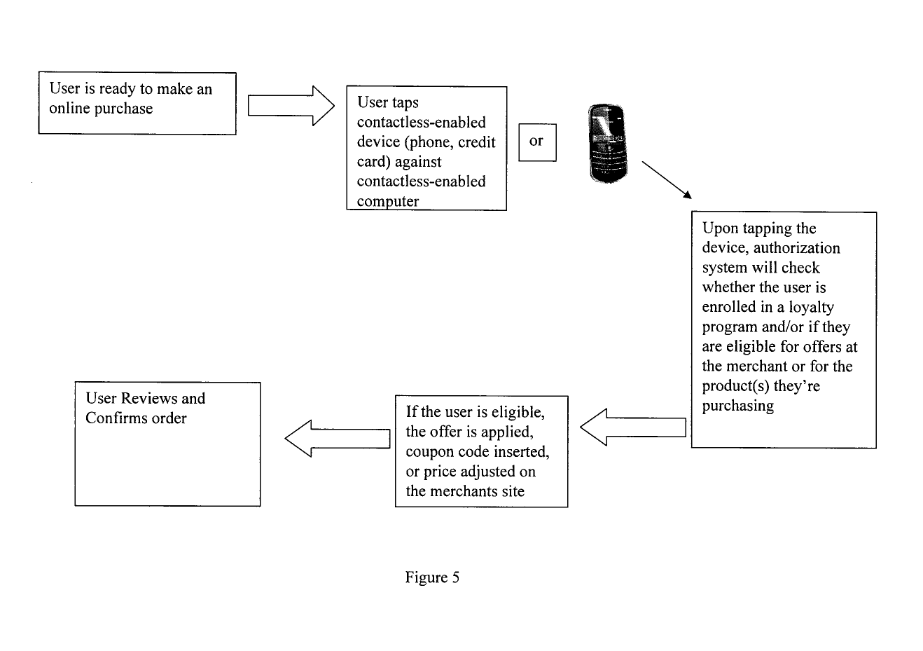

Furthermore, in various exemplary embodiments and with respect to FIG. 5, the authorization system may check the customer account for any relevant loyalty program enrollments or reward programs related to the merchant the user is shopping with or the product or service being purchased. If the current online transaction qualifies for loyalty points or rewards, the authorization system may apply the discount or offer on behalf of the user. The authorization system may provide a coupon code or discount to the merchant system, which may then display the price adjustment to the user.

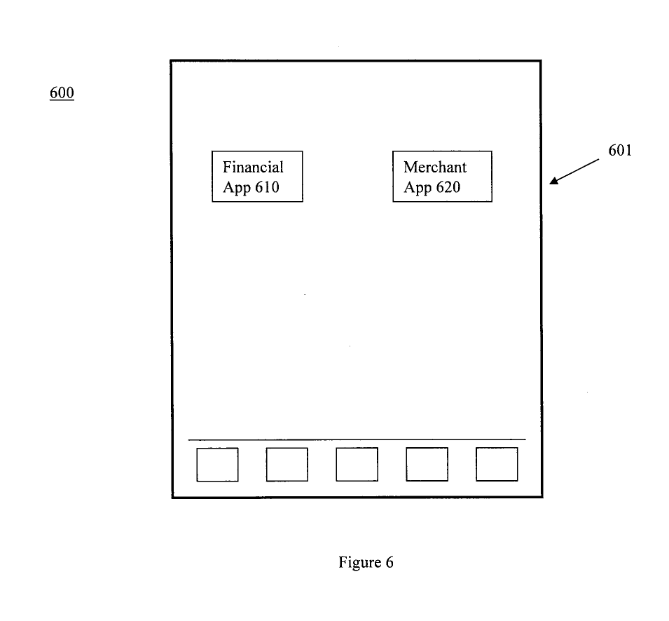

In various embodiments, a system, method and/or computer program product for conducting a contactless online transaction is disclosed. FIG. 6 is an overview of an exemplary system 600 for conducting an online transaction between separate applications on a common computer system 601. The common computer system may be, for example, an iPhone, an iPad, Android device, or similar smart phone or tablet computer. Further, the common computer system may be a desktop computer or the like. System 600 comprises a financial application 610 and a merchant application 620. Merchant application 620 may be an online merchant website accessed through an internet browser on the computer system. Further, merchant application 620 may be a stand-alone application on the common computer system 601. Similar to the embodiments previously described, financial application 610 contains financial information of a customer to be used to facilitate an online transaction. The financial information may contain account numbers, customer identifies, a proxy account identifier, loyalty program identifiers, and the like.

In various embodiments, the financial information is transferred from financial application 610 to merchant application based on at least one of several actions. The several actions may include a drag-and-drop process of dragging an icon representing the financial application 610 on an icon representing the merchant application 620. Similarly, the financial information transferring may occur in response to a customer “flicking” the icon representing the financial application 610 on to the icon representing the merchant application 620. Additionally, the financial information transferring may be responsive to a voice recognition test or biometric test.

One benefit of increasing the transaction security is for the authorization system to classify the transaction as a card-present transaction. The transaction may be classified as card-present even though the transaction may be an online transaction.

The financial application 610 may pre-populate shipping and/or payment information in the merchant application 620. The customer may then verify the pre-populated information, supply additional or alternative information, and confirm the online transaction. In various embodiments, the pre-populated information provided by the financial application 610 may include at least one additional data point that informs an authorization system that the online transaction is implementing an application to application transfer. Furthermore, in various embodiments, financial application 610 provides a personal identifier. Merchant application 620 then transmits the personal identifier and transaction information, including a transaction amount, to the authorization system. The authorization system approves the transaction and transmits an approval code and shipping address to a merchant system of the merchant application 620. The customer may be able to review and confirm the online order prior to the transaction being processed.

Furthermore, the embodiments described above may be implemented in the application to application transfers. This includes, for example, the rotating account code and/or CID, using a unique identifier associated with the computer system, voice activation, and having multiple data sets stored within financial application 610.

Computer system 700 includes at least one processor, such as a processor 702. Processor 702 is connected to a communication infrastructure 704, for example, a communications bus, a cross over bar, a network, and/or the like. Various software embodiments are described in terms of this exemplary computer system 700. After reading this description, it will become apparent to a person skilled in the relevant art(s) how to implement the present embodiments using other computer systems and/or architectures.

The computer system 700 includes a display interface 706 that forwards graphics, text, and other data from the communication infrastructure 704 for display on a display unit 708.

The computer system 700 further includes a main memory 710, such as random access memory (RAM), and may also include a secondary memory 712. The secondary memory 712 may further include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a well known manner. The removable storage unit 718 may represent a floppy disk, magnetic tape or an optical disk, and may be read by and written to by the removable storage drive 716. As will be appreciated, the removable storage unit 718 includes a computer usable storage medium having stored therein, computer software and/or data.

In accordance with various embodiments, the secondary memory 712 may include other similar devices for allowing computer programs or other instructions to be loaded into the computer system 700. Such devices may include, for example, a removable storage unit 720, and an interface 722. Examples of such may include a program cartridge and cartridge interface (such as that found in video game devices), a removable memory chip (such as an erasable programmable read only memory (EPROM), or programmable read only memory (PROM)) and associated socket, and other removable storage unit 720 and interfaces 722, which allow software and data to be transferred from the removable storage unit 720 to the computer system 700.

The computer system 700 may further include a communication interface 724. The communication interface 724 allows software and data to be transferred between the computer system 700 and external devices. Examples of the communication interface 724 include, but may not be limited to a modem, a network interface (such as an Ethernet card), a communications port, a Personal Computer Memory Card International Association (PCMCIA) slot and card, and/or the like. Software and data transferred via the communication interface 724 are in the form of a plurality of signals, hereinafter referred to as signals 726, which may be electronic, electromagnetic, optical or other signals capable of being received by the communication interface 724. Signals 726 are provided to the communication interface 724 via a communication path (e.g., channel) 728. The communication path 728 carries the signals 726 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 716, a hard disk installed in hard disk drive 714, signals 726, and/or the like. These computer program products provide software to the computer system 700. The present disclosure is directed to such computer program products.

Computer programs (also referred to as computer control logic) are stored in the main memory 710 and/or the secondary memory 712. Computer programs may also be received via the communication infrastructure 704. Such computer programs, when executed, enable the computer system 700 to perform the features as discussed herein. In particular, the computer programs, when executed, enable the processor 702 to perform the features of the various embodiments. Accordingly, such computer programs represent controllers of the computer system 700.

In accordance with an embodiment implemented using software, the software may be stored in a computer program product and loaded into the computer system 700 using the removable storage drive 716, the hard disk drive 714 or the communication interface 724. The control logic (software), when executed by the processor 702, causes the processor 702 to perform the functions as described herein. In various embodiments, the present disclosure is implemented primarily in hardware using, for example, hardware components such as application specific integrated circuits (ASIC). Implementation of the hardware state machine so as to perform the functions described herein will be apparent to persons skilled in the relevant art(s).

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THEDEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

“Entity” may include any individual, consumer, consumer, group, business, organization, government entity, transaction account issuer or processor (e.g., credit, charge, etc), merchant, consortium of merchants, consumer, account holder, charitable organization, software, hardware, and/or any other entity.

A “transaction account” or “account” may include any account that may be used to facilitate a financial transaction. A financial institution or transaction account issuer includes any entity that offers transaction account services to consumers. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution, but these participants are not shown.

The transaction account code may be distributed and stored in any form of plastic, electronic, magnetic, radio frequency, wireless, audio and/or optical device capable of transmitting or downloading data from itself to a second device. A consumer account code may be, for example, a sixteen-digit account code, although each credit provider has its own numbering system, such as the fifteen-digit numbering system used by American Express. Each company's account codes comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account code may be, for example, any number or alpha-numeric characters that identify a particular merchant for purposes of account acceptance, account reconciliation, reporting, or the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution. The financial institution may include any entity which processes transactions, issues accounts, acquires financial information, settles accounts, conducts dispute resolution regarding accounts, and/or the like.

The term “merchant” shall include any person, entity, charitable organization, machine, software, hardware, and/or the like that that offers a product or service to a consumer. As used herein, the term “merchant” is used interchangeably with the term “retailer,” “supplier” or “seller”. Moreover, in this context, a merchant may offer or sell, either online or offline, products and/or services made or supplied by at least one manufacturer. As used herein, the phrases “network level” and “network-wide level” shall refer to a system that includes more than one merchant and at least one manufacturer. The merchant's computer system may also be interconnected to a third-party provider via a second network, referred to as a payment network. The payment network represents existing proprietary networks that presently accommodate transactions for credit cards, debit cards, and other types of financial instruments or banking cards. The payment network is a closed network that is assumed to be secure from eavesdroppers. Examples of the payment network include the American Express®, VisaNet®, and the Veriphone® networks.

As used herein, the terms “customer”, “consumer”, “purchaser”, and “end-user” may be used interchangeably with each other, and each shall mean any person, entity, charitable organization, or business which uses a consumer ID to participate in the present system. A “consumer ID”, as used herein, includes any device, code, or other identifier suitably configured to allow the consumer to interact or communicate with the system, such as, for example, a rewards card, charge card, credit card, debit card, prepaid card, telephone card, smart card, magnetic stripe card, bar code card, authorization/access code, personal identification number (PIN), Internet code, other identification code, and/or the like. Additionally, a “consumer ID” may comprise any form of electronic, magnetic, and/or optical device capable of transmitting or downloading data from itself to a second device which is capable of interacting and communicating with such forms of consumer ID.

“Transaction data”, as used herein, comprises data relating to the offer of any item to a consumer or other end-user. Purchase data may include any of the following: an item purchased, an item price, a number of items purchased, a total transaction price, a payment vehicle, a date, a store identifier, an employee identifier, a retailer item identifier, a loyalty identifier, and/or the like.

In yet another embodiment, the present disclosure is implemented using a combination of both the hardware and the software.

Systems, methods and computer program products are provided. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

While various embodiments of the present disclosure have been described above, it should be understood that they have been presented by way of example, and not limitation. It will be apparent to persons skilled in the relevant art(s) that various changes in form and detail can be made therein without departing from the spirit and scope of the present disclosure. Thus, the present disclosure should not be limited by any of the above described exemplary embodiments, but should be defined only in accordance with the following claims and their equivalents.

In addition, it should be understood that the figures illustrated in the attachments, which highlight the functionality and advantages of the present disclosure, are presented for example purposes only. The architecture of the present disclosure is sufficiently flexible and configurable, such that it may be utilized (and navigated) in ways other than that shown in the accompanying figures. The detailed description of exemplary embodiments herein makes reference to the accompanying drawings and figures, which show the exemplary embodiments by way of illustration only. While these exemplary embodiments are described in sufficient detail to enable those skilled in the art, it should be understood that other embodiments may be realized and that logical electrical, organization, and programming-related changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order.

The present disclosure is described herein with reference to block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the disclosure. It should be understood that the detailed description and specific examples, indicating exemplary embodiments of the system, are given for purposes of illustration only and not as limitations. Many changes and modifications within the scope of the instant disclosure may be made without departing from the spirit thereof, and the disclosure includes all such modifications. Corresponding structures, materials, acts, and equivalents of all elements in the claims below are intended to include any structure, material, or acts for performing the functions in combination with other claim elements as specifically claimed. The scope of the disclosure should be determined by the appended claims and their legal equivalents, rather than by the examples given above. Reference to an element in the singular is not intended to mean “one and only one” unless explicitly so stated, but rather “one or more.” Moreover, where a phrase similar to at least one of A, B, and C is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A contactless payment system comprising:
a processor configured to receive consumer information,
a tangible, non-transitory memory configured to communicate with the processor,
the tangible, non-transitory memory having instructions stored thereon that, in response to execution by the processor, cause the processor to perform operations comprising:
initiating, by the contactless payment system, an online transaction based on a consumer selection;
receiving, by the contactless payment system and from a contactless device, the consumer information, wherein the consumer information provides at least one of shipping information, account information, and billing information for completing the online transaction; and
populating, by the contactless payment system, a check-out screen with consumer information from the contactless device,
wherein the consumer confirms the online transaction and associated information.

2. The contactless payment system of claim 1, wherein the consumer information includes a unique identifier associated with the contactless device.

3. The contactless payment system of claim 2, wherein contactless device is a mobile phone and wherein the unique identifier is a phone number of the mobile phone.

4. The contactless payment system of claim 1, wherein the consumer information includes at least one rotating number.

5. The contactless payment system of claim 1, wherein the contactless device provides the consumer information to the computer-based system for pre-populating the merchant website.

6. The contactless payment system of claim 1, wherein the contactless device stores various consumer information, and wherein a selection of the various consumer information is provided to the computer-based system in response to a gesture formation of the contactless device when in proximity to the reader.

7. The contactless payment system of claim 6, wherein the gesture formation is in the form of a shape, and wherein specific shapes correspond to specific consumer information.

8. The contactless payment system of claim 1, wherein the contactless device is capable of transmitting the consumer information to the reader in response to voice activation of the contactless device.

9. The contactless payment system of claim 8, wherein voice activation is based on phrases, and wherein a first phrase corresponds to a first set of consumer information, and wherein a second phrase corresponds to a second set of consumer information.

10. A method comprising:
initiating, at a computer-based system configured to receive consumer information, an online transaction based on a consumer selection;
receiving, by the computer-based system and from a contactless device, the consumer information, wherein the consumer information provides at least one of shipping information, account information, and billing information for completing the online transaction; and
populating, by the computer-based system, a check-out screen with consumer information from the contactless device,
wherein the consumer confirms the online transaction and associated information.

11. The method of claim 10 further comprising:
submitting, by the computer-based system, the online transaction to an authorization system for processing using business as usual standards; and
receiving, at the computer-based system, confirmation that the online transaction is approved by the authorization system.

12. The method of claim 10, wherein the consumer information includes a rotating security number.

13. The method of claim 10, wherein the transmitting from the contactless device comprises transmitting using near-field communication protocols.

14. The method of claim 10, wherein the contactless device stores various consumer information, and wherein a selection of the various consumer information is provided to the computer-based system in response to a gesture formation of contactless device when in proximity to a reader of the computer-based system.

15. A method comprising:
generating, by a computer-based system configured to receive account information, an online transaction order based on input from a consumer;
receiving, at a contactless-enabled device of the computer-based system, the account information from a radio frequency device; and
populating, by the computer-based system, the account information into the online transaction order.

16. The method of claim 15, further comprising:
receiving, at the computer-based system, confirmation of the online transaction order in response to a consumer approval; and
transmitting, by the computer-based system, the online transaction order to an authorization system for processing the transaction under business as usual standards.

17. The method of claim 15, wherein the radio frequency device is at least one of a transponder, a mobile phone, a smart phone, or a fob.

18. The method of claim 15, wherein contactless-enabled device is at least one of a desktop computer, a laptop computer, a tablet computer, a notebook computer, a mobile phone, or a smart phone.

19. The method of claim 15, wherein the radio frequency device is enabled for transmitting the account information to the contactless-enabled device in response to voice activation of the radio frequency device.

20. The method of claim 19, wherein voice activation is based on phrases, and wherein a first phrase corresponds to a first set of account information, and wherein a second phrase corresponds to a second set of account information.
